(19) United States
(12) Patent Application Publication
(10) Pub. No.: US 2009/0263210 A1
(43) Pub. Date: Oct. 22, 2009

(54) Connecting assembly for fastening an add-on element on a carrier element

(75) Inventors: Hubert Loewe, Weselberg (DE); Juergen Hofmann, Eisenberg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TWA Automotive Electronics & Components GmbH

(21) Appl. No.: 12/229,680

(22) Filed: Aug. 26, 2008

(30) Foreign Application Priority Data
Apr. 18, 2008 (DE) 20 2008 005 413.3
Jul. 31, 2008 (DE) 20 2008 010 262.6

(51) Int. Cl. F16B 21/07

(52) U.S. Cl. 411/553

(57) ABSTRACT

A connecting assembly (10) for fastening an add-on element (56) on a carrier element (58) includes a first connecting part (12) which can be inserted into an opening (64) of the carrier element (58). The first connecting part (12) has retaining means for fixing the first connecting part (12) to the carrier element (58). The connecting assembly (10) further includes a second connecting part (14) which can be inserted into a bore (60) of the add-on element (56). The second connecting part (14) is adapted to be inserted into the first connecting part (12). The connecting assembly (10) is adapted to be converted from a pre-mounted state, in which the retaining means permit a removal of the first connecting part (12) from the carrier element (58), into a mounted state, in which the retaining means do not permit a removal of the first connecting part (12) from the carrier element (58). The connecting assembly (10) can be converted from the pre-mounted state into the mounted state by pressing down the second connecting part (14) into the first connecting part (12), and from the mounted state back into the pre-mounted state by a rotation of the second connecting part (14) relative to the first connecting part (12).

### TECHNICAL FIELD

The invention relates to a connecting assembly for fastening an add-on element on a carrier element.

### BACKGROUND OF THE INVENTION

Such connecting assemblies are used in particular in the automotive industry for fastening inner lining parts to car body parts of a motor vehicle.

Different types of devices for fastening add-on elements on carrier elements are known, which are configured as connecting assemblies having two connecting components similar to rivets. A first connecting part (foot) is inserted into an opening formed in the carrier element. A second connecting part (pin) has a shank one end of which is provided with a head. The pin is fitted through a bore or a slotted hole of the add-on element and then coaxially into the foot by means of the shank. The add-on element is then clamped between the head of the pin and the carrier element, and the cooperation between the foot and the pin can take place in various ways.

It is often necessary to remove again an add-on element after the first mounting thereof, particularly to attach certain devices or to carry out maintenance works. In known connecting assemblies, it is then necessary to remove at first the pin and then the foot, provided that this is still possible. This means that the connecting parts have to be detached from each other, a damaging of one of the connecting parts during the removal being not unusual. Furthermore, some connecting techniques do not permit a reuse of the connecting assembly under satisfying circumstances, in particular if the cooperation between the connecting parts occurs under plastic deformation.

Document EP 1 698 785 A1 discloses a connecting assembly including a first connecting part (foot) which can be inserted into an opening of the carrier element and has retaining means for fixing the first connecting part to the carrier element, and a second connecting part (pin) which can be inserted into a bore of the add-on element. The pin is adapted to be inserted into the foot. The connecting assembly is adapted to be converted from a pre-mounted state, in which the retaining means permit a removal of the foot from the carrier element, into a mounted state, in which the retaining means do not permit a removal of the foot from the carrier element. The pin has a shank which can be inserted into an opening of the foot. The foot includes two elastic tongues having arresting means which extend perpendicularly from a plate. The connecting assembly can take a waiting position, in which the pin is retained in the foot and the plate of the foot is clamped between a stop surface and a protrusion of the pin, a locking position and an unlocking position.

Document DE 37 04 696 A1 shows a fastening device for plates having a plug-in part and a reception part in which a recess is provided for the elongated body of the plug-in part. A surrounding retaining portion is formed in the recess and engages a retaining head of the plug-in part and therefore prevents the plug-in part from being withdrawn axially.

Document U.S. Pat. No. 4,276,806 shows a reusable fastening assembly consisting of two plastic parts which are initially captively connected to each other at a predetermined breaking point. When the upper part is inserted into the lower part, it provides for an arresting of the lower part in an opening of the element which is to be fastened. Retaining means of the lower part engage behind the rim of an opening of the carrier so that the element is firmly fastened to the carrier. By lifting the head of the upper part, the latter can be brought out of engagement with the lower part. The element along with the assembly can then be detached from the carrier.

Document EP 1 177 387 B1 discloses a connecting element which is composed of an upper part and of a lower part extending through the upper part, and by means of which it is possible to connect a carrier to a bearing part. In the mounted state, a region of the upper part connected to the bearing part is expanded behind or into a carrier opening. The upper part includes an upper flange having a central inner toothing in which a counter-toothing of the lower part engages. The lower part has in a latching region between two cylindrical sectors a latching recess in which a counter-latch of the upper part is mounted. A shank provided with slots and the flexible sectors of which are provided with an outer toothing adjoins the upper flange of the upper part.

Document DE 603 01 994 T2 relates to a plastic fastening element for fastening a plate to a carrier. The fastening element includes a pin part having a head and a shank, and a body part having a flange and a pair of legs extending therefrom which can be inserted into a bore formed in the carrier. The flange includes a channel which receives the shank of the pin part. The legs are moved away from each other and brought into pressure contact with an inner surface of the carrier bore to thus fasten the fastening element and then the plate to the carrier. An engagement control mechanism formed outside on a leg of the body part controls the pressure contact between the leg and the inner surface of the carrier bore. The force for inserting the pin part into the body part is thus determined. The engagement control mechanism comprises a bore formed in the leg, the pressure force necessary to drive the shank through the bore in the body part being thus reduced.

The known connecting assemblies do not absolutely resist high removal forces. In case particularly high removal forces are prescribed, conventional screw connections are therefore still used which however involve a time-consuming mounting and dismounting.

It is an object of the invention to avoid the disadvantages of the prior art and to propose a cost-effective connecting assembly which ensures a reliable but reversible fastening of the add-on element on the carrier element.

### BRIEF SUMMARY OF THE INVENTION

According to the invention, a connecting assembly for fastening an add-on element on a carrier element includes a first connecting part which can be inserted into an opening of the carrier element. The first connecting part has retaining means for fixing the first connecting part to the carrier element. The connecting assembly further includes a second connecting part which can be inserted into a bore of the add-on element. The second connecting part is adapted to be inserted into the first connecting part. The connecting assembly is adapted to be converted from a pre-mounted state, in which the retaining means permit a removal of the first connecting part from the carrier element, into a mounted state, in which the retaining means do not permit a removal of the first connecting part from the carrier element. The connecting assembly can be converted from the pre-mounted state into the mounted state by pressing down the second connecting part into the first connecting part, and from the mounted state back into the pre-mounted state by a rotation of the second connecting part relative to the first connecting part.

The connecting assembly according to the invention thus distinguishes itself by the fact that the connection between the add-on element and the carrier element can be locked without any tool by simply pressing down the second connecting part, whereas an unlocking is realized by a rotation of the second connecting part, which, as a rule, can only be carried out with a tool. The connection can thus also withstand high removal forces occurring in case of a side impact, for example. On the one hand, the mounting is simplified and, on the other hand, the connection is effectively protected against an undesired removal of the add-on element, since a tool is necessary only for the dismounting.

The first connecting part is preferably a metallic part which in comparison with known plastic expanding rivets withstands much higher forces.

According to the preferred embodiment of the invention, one of the connecting parts takes an axial position relative to the other connecting part in the pre-mounted state, which is different from that in the mounted state.

A ramp structure can ensure that during a rotation of the second connecting part relative to the first connecting part, the axial position of the second connecting part relative to the first connecting part changes.

The ramp structure is preferably designed such that the connecting assembly can be converted from the mounted state into the pre-mounted state by a rotation of the second connecting part through a predetermined angle.

In the preferred embodiment of the invention, the angle amounts to 120°.

According to an advantageous aspect of the invention, the two connecting parts are captively held together in the pre-mounted state so that logistical advantages (storing, delivery etc.) result therefrom.

### BRIEF DESCRIPTION OF THE DRAWINGS

FIGS. 1 and 2 show in a perspective view a first embodiment of a connecting assembly according to the invention in the pre-mounted state;

FIGS. 3 and 4 show in a perspective view the expanding pin of the connecting assembly of FIG. 1;

FIGS. 5 and 6 show in a perspective view the foot of the connecting assembly of FIG. 1;

FIG. 7 shows in a perspective view the connecting assembly of FIG. 1 in the mounted state with the add-on element and the carrier;

FIG. 8 shows in a perspective view the connecting assembly of FIG. 1 with the add-on element and the carrier during the dismounting;

FIG. 9 shows in a perspective view the connecting assembly of FIG. 1 with the add-on element and the carrier in the unlocked state;

FIG. 10 shows in a perspective view the connecting assembly of FIG. 1 with the add-on element and the carrier in the mounted state with an alternative fastening portion of the add-on element;

FIG. 11 shows in a perspective view a second embodiment of a connecting assembly according to the invention in the pre-mounted state;

FIG. 12 shows in a perspective view the expanding pin of the connecting assembly of FIG. 11;

FIG. 13 shows in a perspective view an enlarged partial view of the expanding pin of FIG. 12;

FIG. 14 shows in a perspective view the foot of the connecting assembly of FIG. 11;

FIG. 15 shows in a perspective view the connecting assembly of FIG. 11 in the mounted state with the add-on element and the carrier;

FIG. 16 shows in a perspective view the connecting assembly of FIG. 11 with the add-on element and the carrier during the dismounting; and

FIG. 17 shows in a perspective view the connecting assembly of FIG. 11 with the add-on element and the carrier in the unlocked state.

### DETAILED DESCRIPTION OF THE PREFERRED EMBODIMENTS

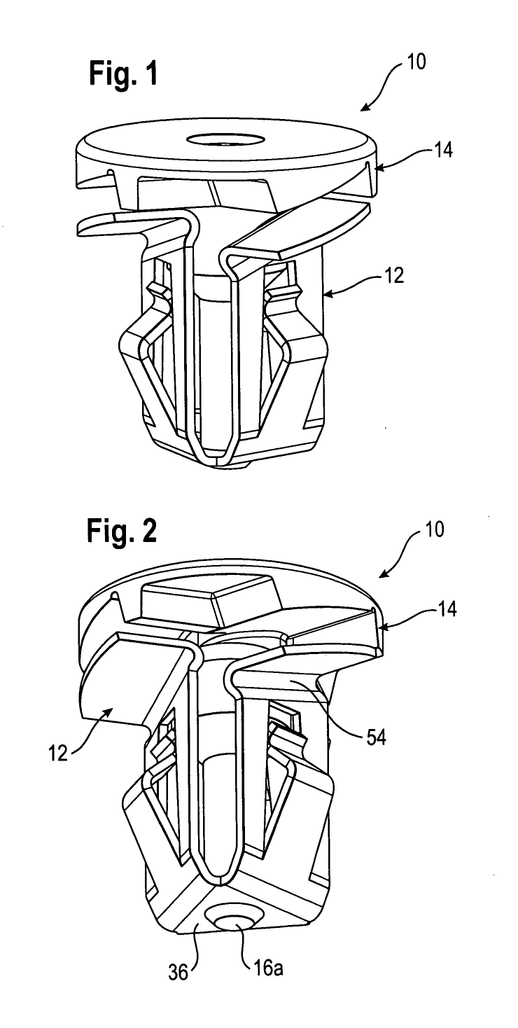

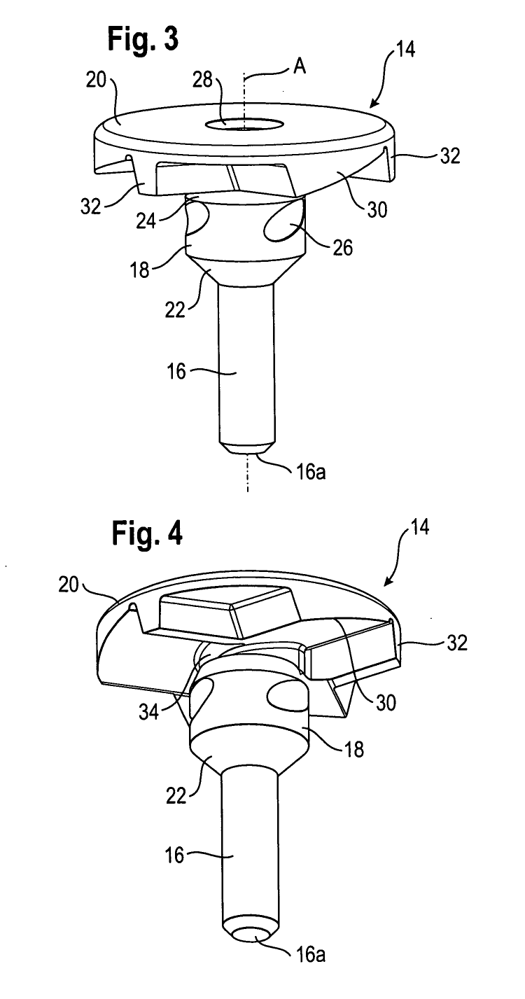

The connecting assembly 10 according to a first embodiment, which is illustrated in FIGS. 1 and 2, consists of a first connecting part 12 in the form of a clamp-like foot, and of a second connecting part 14 in the form of an expanding pin which are each shown individually in different views in FIGS. 5 and 6, and 3 and 4, respectively in an unstressed state. For the sake of simplicity, the first connecting part is always referred to as foot 12, and the second connecting part is always referred to as expanding pin 14 below, but these designations are not to be taken in a limiting sense.

The expanding pin 14 is a plastic part formed in one piece which includes along a longitudinal axis A a guiding portion 16, a central portion 18 and a head portion 20. The elongated guiding portion 16 and the central portion 18 have an essentially cylindrical form and are connected to each other via a truncated transition portion 22, the central portion 18 having an outer diameter which is larger than that of the guiding portion 16. The head portion 20 has an even larger outer diameter and is connected to the central portion 18 via a shank portion 24 on the side facing the guiding portion 16.

The end 16a of the guiding portion 16 facing away from the central portion 18 is tapered. The central portion 18 includes a plurality of latching recesses 26 that are distributed over its circumference. A reception 28 for a Torx™ wrench or a similar screw tool, which is accessible from the side facing away from the central portion 18 is formed in the head portion 20. On the side facing the central portion 18, several axially inclined ramps 30 and the same number of stops 32 extend from the shank region 24 outwards in the radial direction. Latching faces 34 are provided at the points of the shank region 24 not covered by the ramps 30 and the stops 32 which are distributed in the peripheral direction.

In contrast to the expanding pin 14, the foot 12 is a metallic part. Several mounting portions 38 extend from a bottom 36 in an axial direction, the respective longitudinal axis B being defined by a central guiding bore 39 in the bottom 36. The number of mounting portions 38 respectively corresponds to the number of the ramps 30, the stops 32 and the latching recesses 26 of the expanding pin 14 (in the illustrated embodiment: three).

Each mounting portion 38 includes a frame 40 and an expanding element 42 having a retaining portion 44 which projects radially outwards and is formed between two ramp-like portions 46 and 48. The expanding element 42 which has one end connected to the bottom 36 further includes a clamping portion 50 at the opposite end. Owing to its one-sided mounting, the expanding element 42 can be pivoted (against a return force) about an axis C which is perpendicular to the longitudinal axis B. The dimensions of the frame 40 and the expanding element 42 are adapted to each other such that the expanding element 42, in particular the clamping portion 50 thereof, can be moved through the frame 40.

Each mounting portion 38 further has a ramp 52 which projects radially outwards and is connected via a latching portion 54 to that end of the frame 40 that is opposed to the bottom 36. The size and the inclination of the ramps 52 of the foot 12 are adapted to the ramps 30 of the expanding pin 14 so that the ramps 52 of the foot 12 are referred to as complementary ramps 52 below.

The two components 12, 14 of the connecting assembly 10 are connected to each other by inserting the expanding pin 14 so far into the foot 12 until the latching portions 54 of the foot 12 latches into the latching recesses 26 of the expanding pin 14. The tapering of the guiding shank 16 at the end 16a thereof simplifies the insertion into the bore 39 of the foot 12. The latching connection ensures that the expanding pin 14 and the foot 12 are captively held together. As mentioned above, this state of the connecting assembly 10 is referred to as pre-mounted state (see FIGS. 1 and 2). It should be noted that the arrangement of the latching recesses 26 and the arrangement of the latching portions 54 are adjusted to each other such that in case of a correct latching, the foot 12 takes a predetermined angular position relative to the expanding pin 14 with respect to the longitudinal axes A and B. In this position, the ramps 30 of the expanding pin 14 and the complementary ramps 52 of the foot 12 are exactly opposite each other, whereas no part of the foot 12 is opposite the stops 32 of the expanding pin 14.

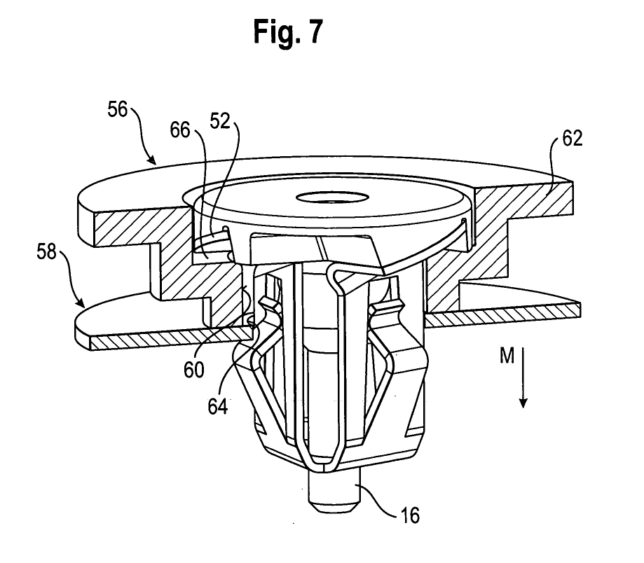

For fastening an add-on element 56 to a carrier element 58 (see FIG. 7), the connecting assembly 10 provided in the pre-mounted state is at first guided through a stepped bore 60 in a fastening portion 62 of the add-on element 56 and then through an opening 64 in the carrier element 58. Since in the pre-mounted state the clamping portions 50 of the foot 12 are opposite the guiding portion 16 of the expanding pin 14 but do not rest against the latter, the expanding elements 42 can pivot inwards to permit the guiding through the bore 60 and the opening 64. After the passage through the opening 64, the expanding elements 42 pivot automatically to the outside again and engage behind the rim of the opening 64, whereas the ends of the complementary ramps 52 of the foot 12, which face the bottom 36, rest on a step 66 of the fastening portion 62.

In order to prevent a removal of the add-on element 56 or of the connecting assembly 10 from the carrier element 58, the connection has to be locked. To this end, the connecting assembly 10 is converted from the pre-mounted state into the mounted state shown in FIG. 7 by pressing down the expanding pin 14 relative to the foot 12 further in the mounting direction M until the latching portions 54 of the foot 12 are in engagement with the latching faces 34 on the shank portion 24 of the expanding pin 14 without a rotation of the expanding pin 14. This is possible because in the angular position dictated in the pre-mounted state, the ramps 30 of the expanding pin 14 can be lowered as far as onto the complementary ramps 52 of the foot 12 and there are no obstacles opposite the stops 32 of the expanding pin 14.

When the expanding pin 14 is pressed in, the clamping portions 50 slide via the transition portion 22 onto the central portion 18 of the expanding pin 14. In this position, the expanding elements 42 cannot pivot inwards anymore so that the now stationary retaining portions 44 of the expanding element 42 firmly hold the add-on element 56 on the carrier element 58. The mounted state is recognizable from the outside in that the head portion 20 of the expanding pin 14 does not project beyond the fastening portion 62 of the add-on element 56 anymore.

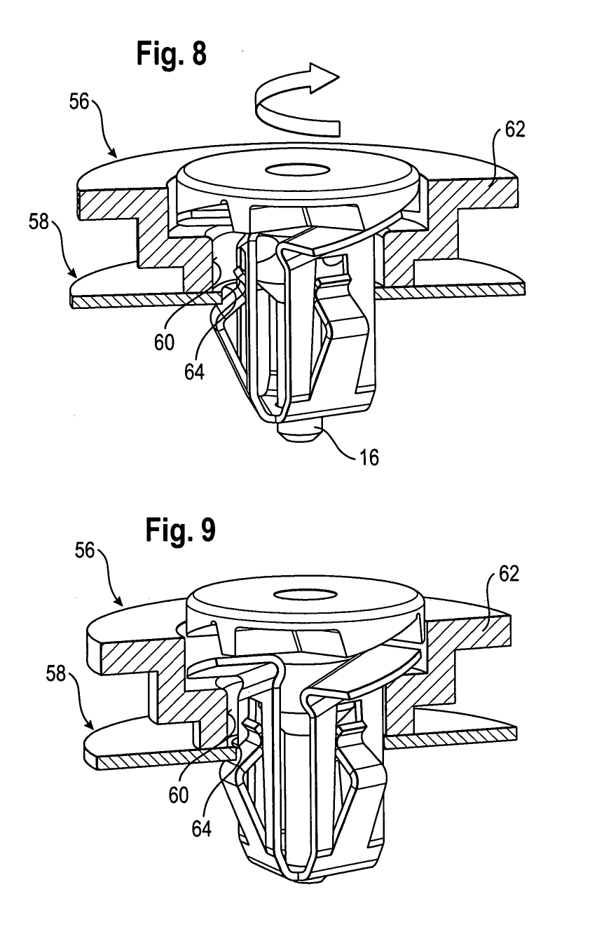

However, a dismounting of the add-on element 56 is possible. The expanding pin 14 can be rotated by means of an appropriate screw tool, as indicated in FIG. 8 by the arrow. Due to the ramp structure, the expanding pin 14 moves away from the foot 12 in the axial direction (contrary to the mounting direction M). The forms of the latching recesses 26 and of the latching faces 34 are adapted to the movement of the expanding pin 14 relative to the foot 12, which has a component in the peripheral direction and an axial component. After a rotation through a determined angle of rotation which depends on the number and on the arrangement of the ramps 30, 52 (in the illustrated embodiment: 120°), the connecting assembly 10 is unlocked, and the stable pre-mounted state of the connecting assembly 10 is obtained (see FIG. 9). In the pre-mounted state, the expanding elements 42 can pivot inwards again so that the connecting assembly 10 and the add-on element 56 can be removed from the carrier element 58.

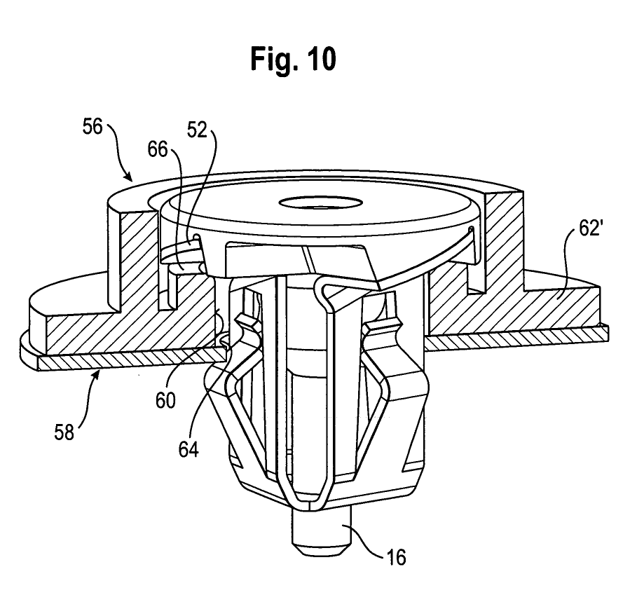

FIG. 10 shows the same connecting assembly 10 in the mounted state, the fastening portion 62′ of the add-on element 56 having a different configuration. The alternative fastening portion 62′ however also has a bore 60 and a step 66 on which the ends of the complementary ramps 52 of the foot 12 rest.

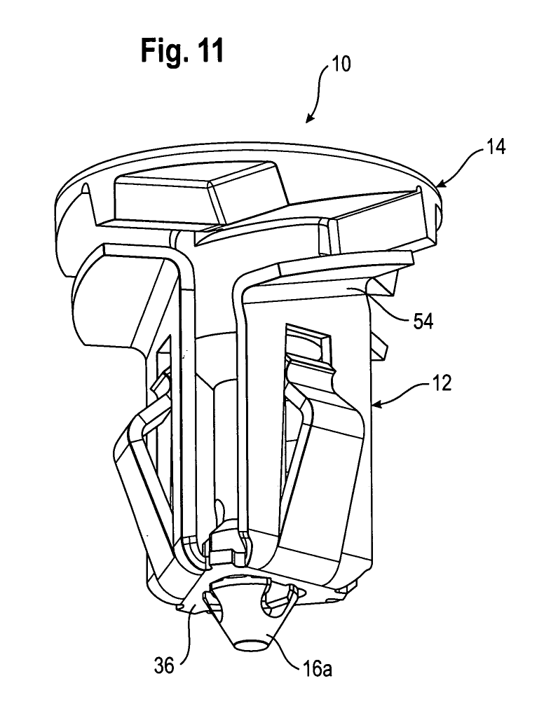

FIGS. 11 to 17 show a connecting assembly according to a second embodiment. The second embodiment is very similar to the first embodiment described above, so that merely the differences are discussed below. The same reference numerals were used for the components corresponding to, and having the same function as, those of the first embodiment, and in so far, reference is made to the explanations above.

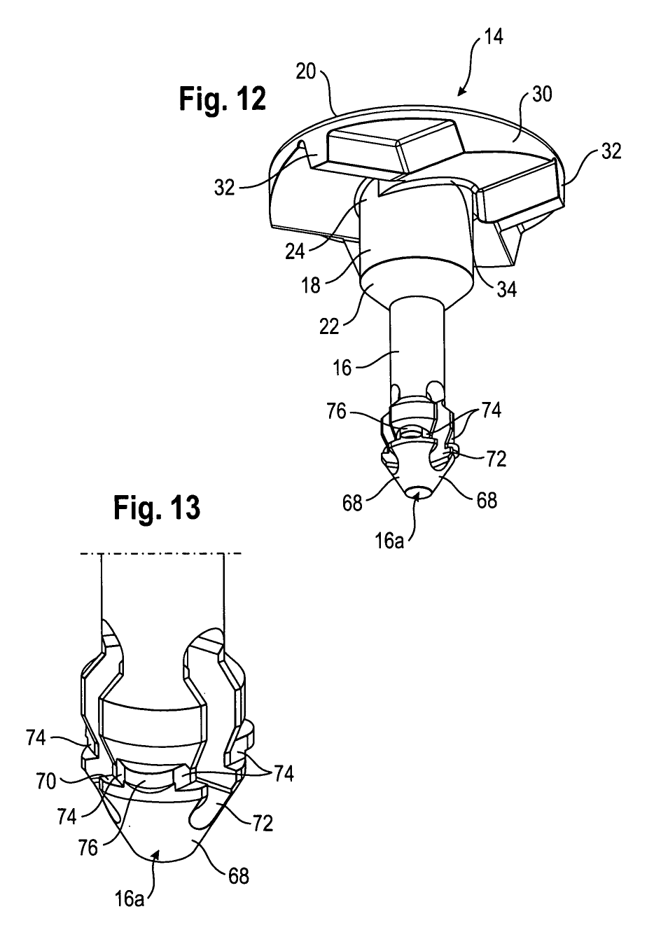

The expanding pin 14 of the second embodiment differs from the expanding pin of the first embodiment in that no latching recesses are provided on the central portion 18, and in that the region of the guiding portion 16 facing away from the central portion 18 has a different design (see FIGS. 12 and 13). As in the first embodiment, the end 16a of the guiding portion 16 is tapered; it is however largely hollow. Several resilient wall portions 68 having axial locating faces 70 are delimited from each other by partial clearances 72. Several lateral locating faces 74, which are interrupted by the partial clearances 72, are formed above the axial locating faces 70 and in a perpendicular orientation thereto. Regions 76 projecting in the radial direction with respect to the rest of the wall portions 68 are located between the lateral locating faces 74.

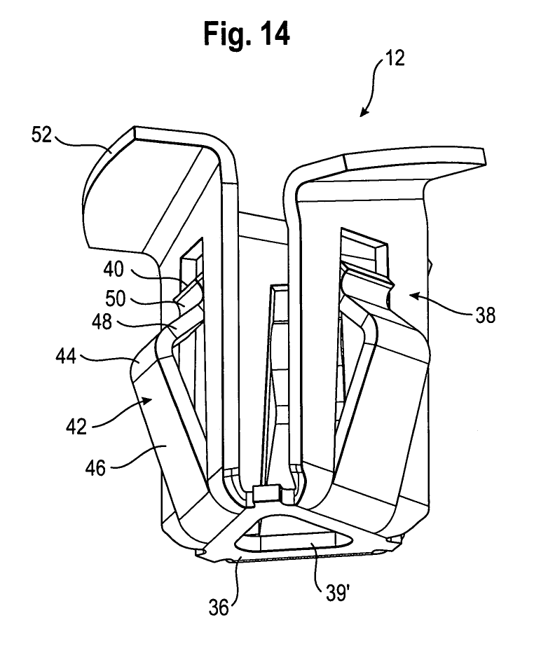

In the foot 12 of the second embodiment, the bore 39′ in the bottom 36 is polygonal rather than circular; however, the “corners” of the bore 39′ may be rounded (see FIG. 14). The rim of the bore 39′ corresponds exactly to the course of the lateral locating faces 74 and of the projecting regions 76 of the expanding pin 12. The mounting portions 38 extend from the oblong rim portions of the bore 39′. The number of the mounting portions 38 corresponds respectively to the number of the corners of the bore 39′, the ramps 30, the stops 32 and the wall portions 68 of the expanding pin 14 (in the illustrated embodiment: three).

To bring the two components 12, 14 of the connecting assembly 10 into the pre-mounted state, the expanding pin 14 is inserted under elastic deformation of the wall portions 68 so far into the foot 12 until the wall portions 68 take again their initial position where the axial locating faces 70 then engage behind the rim of the bore 39′, and the rim of the bore 39′ rests against the lateral locating faces 74 (see FIG. 11).

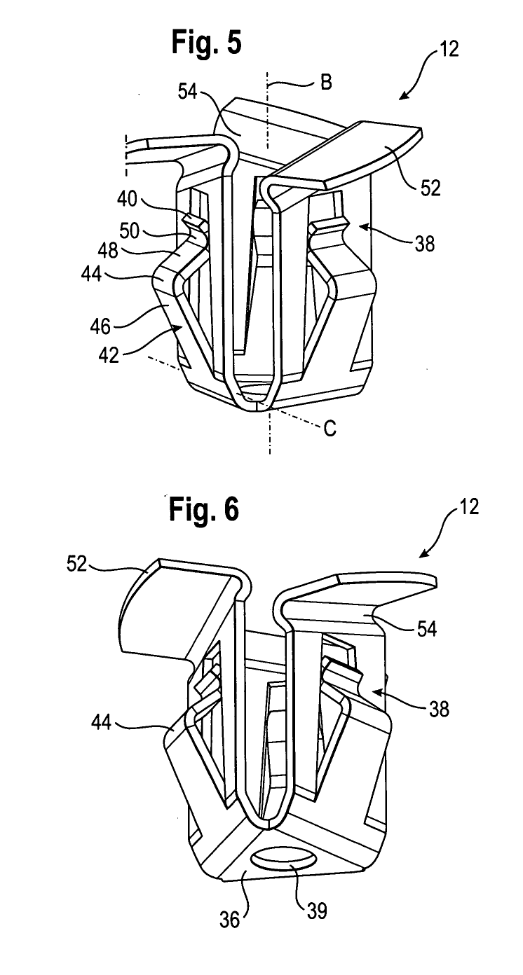

As in the first embodiment, the latching connection realized in this way ensures that the expanding pin 14 and the foot 12 are captively held together. It should also be noted that the configuration of the lateral locating faces 74, that of the projecting regions 76 and that of the bore 39 are adapted to each other such that in case of a correct latching, the foot 12 takes a predetermined angular position relative to the expanding pin 14 with respect to the longitudinal axes A and B (cf. FIGS. 3 and 5). In this position, the ramps 30 of the expanding pin 14 and the complementary ramps 52 of the foot 12 are exactly opposite each other, whereas no part of the foot 12 is opposite the stops 32 of the expanding pin 14.

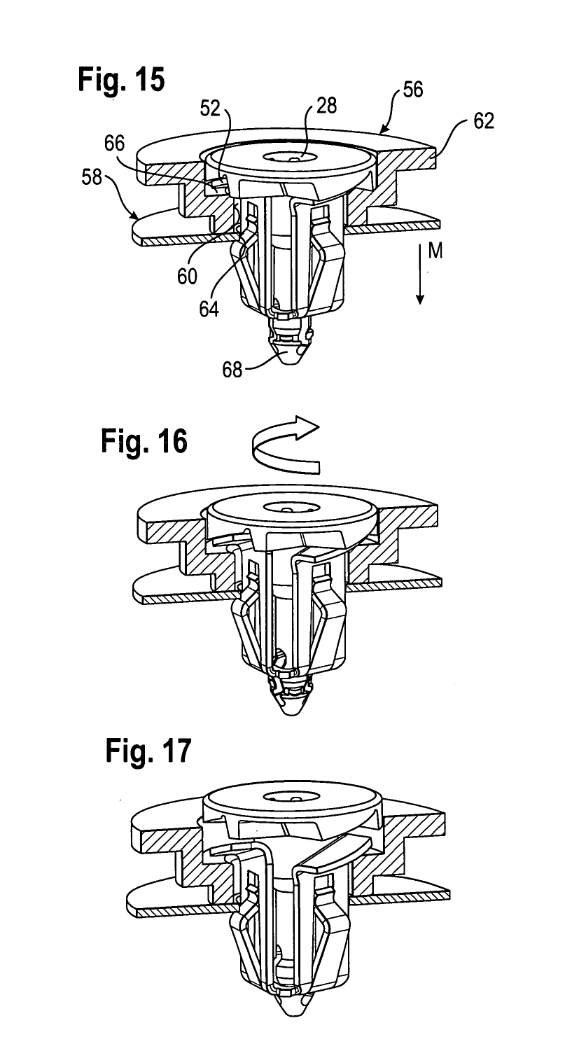

The fastening and locking of an add-on element 56 on a carrier element 58 by means of the connecting assembly is carried out in a way similar to that of the first embodiment by further pressing down the expanding pin 14 relative to the foot 12 in the mounting direction M, without a rotation of the expanding pin 14. The mounted state of the connecting assembly 10 is shown in FIG. 15.

The dismounting of the add-on element 56 also takes place in a way similar to that in the first embodiment. During the rotation of the expanding pin 14, the expanding pin 14 is lifted from the foot 12 in the axial direction (see FIG. 16). After a determined angle of rotation, which depends on the number and the arrangement of the ramps 30, 52 (in the illustrated embodiment: 1200), the connecting assembly 10 is unlocked, and the stable pre-mounted state of the connecting assembly 10 is obtained (see FIG. 17) in which the expanding elements 42 can be pivoted inwards again so that the connecting assembly 10 and the add-on element 56 can be removed from the carrier element 58.

In the embodiments shown in the Figures, the connecting assembly 10 is composed only of the expanding pin 14 and the foot 12. However, the connecting parts can also have a different configuration in as far as they have the same functionality according to the invention. More sophisticated embodiments are also possible, which have one or more sealing portions or a separate sealing part for sealing the bore 60 of the add-on element 56 and/or the opening 64 of the carrier element 58.

Though the invention is preferably applicable in the field of the lining of structures, and in particular in the field of motor vehicles and the lining of the car body with an inner lining, the invention was generally described on the basis of a reversible fastening of an add-on element on a carrier element, in which the add-on element can be an inner lining part and the carrier element can be a car body part of a motor vehicle.

1. A connecting assembly for fastening an add-on element on a carrier element, the connecting assembly comprising
a first connecting part which can be inserted into an opening of the carrier element and has retaining means for fixing the first connecting part to the carrier element, and
a second connecting part which can be inserted into a bore of the add-on element,
the second connecting part being adapted to be inserted into the first connecting part,
the connecting assembly being adapted to be converted from a pre-mounted state, in which the retaining means permit a removal of the first connecting part from the carrier element, into a mounted state, in which the retaining means do not permit a removal of the first connecting part from the carrier element,
the connecting assembly being adapted to be converted from the pre-mounted state into the mounted state by pressing down the second connecting part into the first connecting part, and from the mounted state back into the pre-mounted state by a rotation of the second connecting part relative to the first connecting part.

2. The connecting assembly according to claim 1, wherein the first connecting part is a metallic part.

3. The connecting assembly according to claim 1, wherein the second connecting part is a plastic part.

4. The connecting assembly according to claim 1, wherein the second connecting part has a reception for a screw tool by which the second connecting part can be rotated relative to the first connecting part.

5. The connecting assembly according to claim 1, wherein in the pre-mounted state, one of the connecting parts takes an axial position relative to the other connecting part, which is different from that in the mounted state.

6. The connecting assembly according to claim 5, further comprising a ramp structure which ensures, during a rotation of the second connecting part relative to the first connecting part, that the axial position of the second connecting part relative to the first connecting part changes.

7. The connecting assembly according to claim 6, wherein the ramp structure is designed such that the connecting assembly can be converted from the mounted state into the pre-mounted state by a rotation of the second connecting part through a predetermined angle.

8. The connecting assembly according to claim 7, wherein the angle amounts to 120°.

9. The connecting assembly according to claim 1, wherein one connecting part has a tapered end which can be inserted into a bore of the other connecting part.

10. The connecting assembly according to claim 1, wherein in the pre-mounted state, the two connecting parts are captively held together.

11. The connecting assembly according to claim 1, wherein in the pre-mounted state, latching portions of one of the connecting parts cooperate with latching recesses of the other connecting part.

12. The connecting assembly according to claim 11, wherein in the pre-mounted state, the latching portions and the latching recesses dictate a determined angular position of the two connecting parts relative to each other, which permits a further insertion of the second connecting part into the first connecting part.

13. The connecting assembly according to claim 1, wherein in the pre-mounted state, locating faces of one of the connecting parts cooperate with the rim of a bore of the other connecting part.

14. The connecting assembly according to claim 13, wherein in the pre-mounted state, the locating faces and the rim of the bore dictate a determined angular position of the two connecting parts relative to each other, which permits a further insertion of the second connecting part into the first connecting part.

15. The connecting assembly according to claim 1, wherein in the mounted state, latching portions of one of the connecting parts cooperate with latching faces of the other connecting part.

16. The connecting assembly according to claim 1, wherein the retaining means include at least one expanding element having a retaining portion which can be pivoted radially inwards in the pre-mounted state, but not in the mounted state, to permit the passage of the first connecting part through an opening of the carrier element.

17. The connecting assembly according to claim 16, wherein the expanding element has a clamping portion which rests against a portion of the second connecting part under prestress in the mounted state, but not in the pre-mounted state.
